(19) United States
(12) Patent Application Publication
(10) Pub. No.: US 2015/0231942 A1
(43) Pub. Date: Aug. 20, 2015

(54) METHOD AND APPARATUS FOR SUSPENSION DAMPING

(71) Applicant: GM GLOBAL TECHNOLOGY OPERATIONS LLC, DETROIT, MI (US)

(72) Inventors: KLAUS TRANGBAEK, MOSHAV EIN VERED (IL); VLADIMIR SUPLIN, MODIIN (IL)

(73) Assignee: GM GLOBAL TECHNOLOGY OPERATIONS LLC, DETROIT, MI (US)

(21) Appl. No.: 14/181,667

(22) Filed: Feb. 15, 2014

(51) Int. Cl. B60G 15/04; B60G 17/06; F16F 6/00

(52) U.S. Cl. CPC B60G 15/04; F16F 6/00; B60G 17/06; B60G 2202/30; B60G 2500/10

(57) ABSTRACT

A load-carrying spring is coupled between a sprung element and an unsprung element. A magnetic lead screw damper is coupled between the sprung element and the unsprung element. The magnetic lead screw damper includes a magnetic lead screw arranged in series with an electric motor, and the magnetic lead screw includes a rotor screw and a stator nut. The rotor screw includes a rotor magnet assembly forming first helical magnetic threads, and is rotatably coupled to the electric motor. The stator nut includes a stator magnet assembly forming second helical magnetic threads, and a stator frame. The stator magnet assembly includes an axial length equal to an axial length of the rotor magnet assembly. Rotation of the rotor screw effects linear translation of the stator nut by interaction of the first and second helical magnetic threads.

### TECHNICAL FIELD

This disclosure relates to devices for damping vibration between a sprung element and an unsprung element.

### BACKGROUND

The statements in this section merely provide background information related to the present disclosure. Accordingly, such statements are not intended to constitute an admission of prior art.

Suspension systems absorb and dissipate vibration inputs, thus decoupling a sprung element from impulse and vibration energy inputs experienced at an unsprung element. Suspension systems are employed on both stationary systems and mobile systems including passenger vehicles. Known suspension system elements include springs coupled in parallel and/or in series with damping elements, e.g., shock absorbers that include fluidic or pneumatic energy absorbing and dissipating features.

When employed on a vehicle system, suspension systems including springs and dampers are configured to coincidently provide performance characteristics related to passenger ride comfort, vehicle handling and road holding capability. Ride comfort is generally managed in relation to spring constant of the main springs of the vehicle, spring constant of passenger seating, tires and a damping coefficient of the damper. For optimum ride comfort, a relatively low damping force for a soft ride is preferred. Vehicle handling relates to variation in a vehicle's attitude, which is defined in terms of roll, pitch and yaw. For optimum vehicle handling, relatively large damping forces or a firm ride are required to avoid excessively rapid variations in vehicle attitude during cornering, acceleration and deceleration. Road holding ability generally relates to an amount of contact between tires and the ground. To optimize road handling ability, large damping forces are required when driving on irregular surfaces to prevent loss of contact between individual tires and the ground. Known vehicle suspension dampers employ various methods to adjust damping characteristics to be responsive to changes in vehicle operational characteristics, including active damping systems.

### SUMMARY

A load-carrying spring is coupled between a sprung element and an unsprung element. A magnetic lead screw damper is coupled between the sprung element and the unsprung element. The magnetic lead screw damper includes a magnetic lead screw arranged in series with an electric motor, and the magnetic lead screw includes a rotor screw and a stator nut. The rotor screw includes a rotor magnet assembly forming first helical magnetic threads, and is rotatably coupled to the electric motor. The stator nut includes a stator magnet assembly forming second helical magnetic threads, and a stator frame. The stator magnet assembly includes an axial length equal to an axial length of the rotor magnet assembly. Rotation of the rotor screw effects linear translation of the stator nut by interaction of the first and second helical magnetic threads.

### BRIEF DESCRIPTION OF THE DRAWINGS

One or more embodiments will now be described, by way of example, with reference to the accompanying drawings, in which:

FIG. 1 illustrates a passive suspension assembly including a magnetic lead screw (MLS) damper that is employed to dampen vibration between a sprung element and an unsprung element, in accordance with the disclosure;

FIG. 2 illustrates a side-view of an embodiment of an MLS damper that is configured to provide vibration damping between the sprung element and the unsprung element, in accordance with the disclosure;

FIG. 3-1 illustrates a suspension assembly including a load-carrying spring arranged in parallel with an MLS damper between the sprung element and the unsprung element, in accordance with the disclosure;

FIG. 3-2 illustrates a suspension assembly including a load-carrying spring arranged in parallel with an assembly that includes an MLS damper arranged in series with one or a pair of springs, in accordance with the disclosure;

FIG. 3-3 illustrates a suspension assembly including a load-carrying spring arranged in parallel with a damper and a spring/damper assembly that includes an MLS damper, in accordance with the disclosure;

FIG. 3-4 illustrates a suspension assembly including a first spring arranged in series with a parallel arrangement of a second spring and an MLS damper, in accordance with the disclosure;

FIG. 4-1 illustrates portions of an MLS including a stator magnet assembly that extends axially along the entire length of a stator frame and a rotor magnet axial length that is less than a stator magnet axial length, in accordance with the disclosure;

FIG. 4-2 illustrates portions of an MLS including a stator magnet assembly that extends axially along a middle section of the stator frame and corresponds in length to a rotor magnet axial length, in accordance with the disclosure;

FIG. 4-3 illustrates portions of an MLS including a stator frame that includes a stator magnet assembly and conductive inserts, and a rotor including a rotor magnet assembly, in accordance with the disclosure;

FIG. 5 illustrates portions of an MLS including a stator frame that includes a stator magnet assembly including electric coil elements and a rotor including a rotor magnet assembly, in accordance with the disclosure;

FIG. 6 illustrates portions of an MLS including a stator frame that includes a stator magnet assembly and a rotor with a non-ferrous core and a ferrous threaded portion adjacent to the stator magnet assembly, in accordance with the disclosure; and

FIG. 7 illustrates frequency response data associated with a suspension assembly wherein an MLS is part of a tuned mass damper arranged between a vehicle chassis and a vehicle wheel, in accordance with the disclosure.

### DETAILED DESCRIPTION

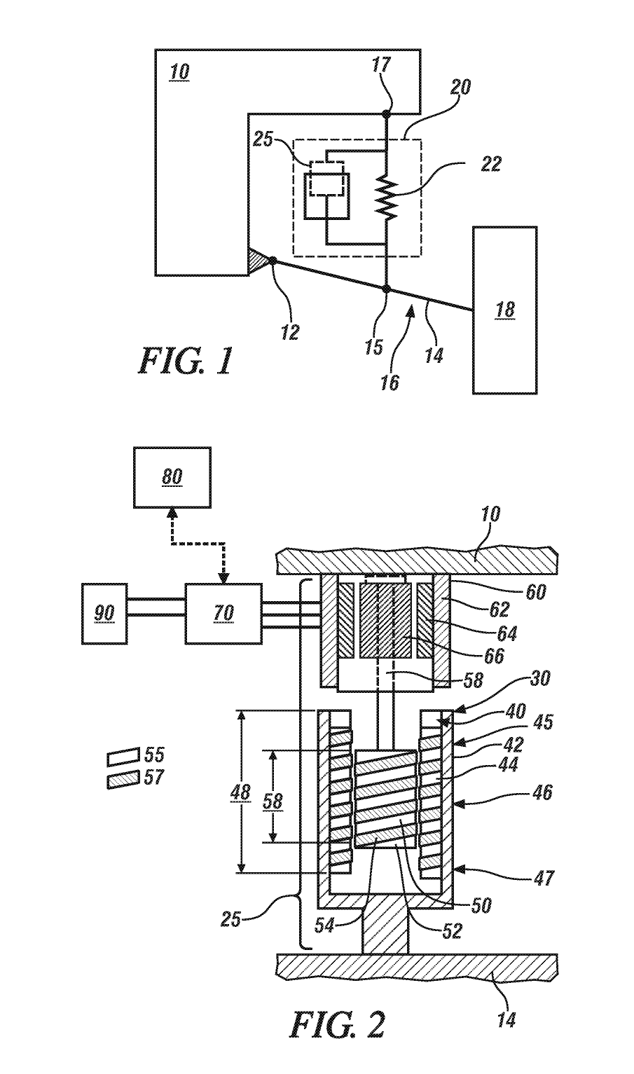

Referring now to the drawings, wherein the showings are for the purpose of illustrating certain exemplary embodiments only and not for the purpose of limiting the same, FIG. 1 schematically illustrates a suspension assembly 20 including a load-carrying spring 22 coupled between a sprung element and an unsprung element. The suspension assembly 20 also includes a magnetic lead screw (MLS) damper 25 coupled between the sprung element and the unsprung element. The load-carrying spring 22 and the MLS damper 25 are arranged in parallel. As illustrated, the sprung element is a chassis 10 of a vehicle and the unsprung element 16 includes a lower control arm 14 supporting a wheel assembly 18 that contacts a ground surface. The lower control arm 14 attaches to the chassis 10 at hinge point 12, and works in concert with an upper control arm or another attachment point to the chassis 10 to provide seating elements for mounting the wheel assembly 18. Details for mounting a wheel assembly 18 are various and known and thus not described herein. The suspension assembly 20 may be employed to dampen vibration between a sprung element and an unsprung element in a stationary setting with similar effect. The suspension assembly 20 incorporates the MLS damper 25 to achieve preferred suspension performance in response to static and dynamic loading to isolate the chassis 10 from vibrations and stabilize the chassis 10 during vehicle maneuvering. Static load is understood to be the magnitude of force exerted by the chassis 10 on the suspension assembly 20 and wheel assembly 18 when the chassis 10 is at rest. Such a system provides desirable ride performance for passenger comfort and wheel/tire road grip while accommodating static load changes due to mass changes and accommodating dynamic load changes during handling maneuvers when employed on a vehicle. The terms spring rate, spring constant and stiffness are analogous terms that all refer to a change in force exerted by a spring in relation to the deflection of the spring.

The suspension assembly 20 is a load-carrying element that supports and transfers static and dynamic forces and load inputs between the unsprung element 16 and the sprung element 10, i.e., the lower control arm 14 and the chassis 10. The suspension assembly 20 in the embodiment shown includes spring 22 and MLS damper 25 arranged in parallel between the lower control arm 14 and the chassis 10. As shown, the spring 22 and MLS damper 25 co-terminate on the lower control arm 14 at hinge point 15 and co-terminate on the chassis at hinge point 17. Alternatively, the spring 22 and MLS damper 25 can terminate on the lower control arm 14 at different hinge points and/or terminate on the chassis 10 at different hinge points, resulting in different moment arms for the forces exerted by the different elements. Under static loading conditions, the spring 22 supports all of the load input from the chassis 10 and the MLS damper 25 is at a nominal displacement. Introduction of a dynamic load causes displacement of the spring 22 in concert with the MLS damper 25.

FIG. 2 schematically shows a side-view of an embodiment of the MLS damper 25 that is configured to provide vibration damping between the sprung element 10 and the unsprung element 16. The MLS damper 25 includes MLS 30 that rotatably couples in series with an electric motor 60 between the sprung element 10 and the unsprung element 16. The MLS 30 is analogous to a mechanical lead screw wherein the mechanical coupling in the form of opposed helical threads is replaced by a functionally equivalent magnetic coupling in the form of radially polarized helical magnets having opposite polarity, as described herein. The MLS 30 includes a stator nut 40 and a concentric rotor screw 50. As shown, the stator nut 40 is configured as a female translating portion of the MLS 30 and is analogous to a threaded nut. As shown, the rotor screw 50 is configured as a male rotating portion of the MLS 30 and is analogous to a threaded screw. Alternatively, the stator nut 40 can be configured as a translating male portion of the MLS 30 and the rotor screw 50 can be configured as a rotating female portion of the MLS 30. Rotation of the rotor screw 50 in the stator nut 40 causes a linear translation of the rotor screw 50 in relation to the stator nut 40 by interaction of helical magnetic threads. Rotation of the rotor screw 50 can be caused by rotation of the electric motor 60 acting as a motor in response to electric energy input thereto. Rotation of the rotor screw 50 can be caused by compressive force or tensile force between the sprung element 10 and the unsprung element 16, which causes the rotor screw 50 to rotate within the stator nut 40 with corresponding rotation of the electric motor 60. The electric motor 60 may act as a generator in such circumstances to harvest electric power. Rotation of the rotor screw 50 either increases or decreases a linear distance between the sprung element 10 and the unsprung element 16 depending upon the direction of rotation, with an accompanying tensile or compressive force that is dependent upon the forces acting on the sprung element 10 and the unsprung element 16. Thus, linear translation of the rotor screw 50 in relation to the stator nut 40 adjusts displacement of the sprung element 10 in relation to the unsprung element 16. Damping is introduced by controlling the rate of the linear translation of the rotor screw 50 in relation to the stator nut 40.

The stator nut 40 includes a cylindrically-shaped annular frame 42 and a stator magnet assembly 44 fabricated on an inner surface of the annular frame 42. The stator magnet assembly 44 includes a continuous helical magnetic thread formed, for example, from a plurality of permanent magnet elements. The stator magnet assembly 44 is arranged as a plurality of interleaved magnet sections forming a spirally-wound thread formed from radially polarized magnets of opposite polarity. Polarities are shown merely for purposes of illustration of the concept, and include a north polarity portion 55 and a south polarity portion 57. The stator frame 42 includes a first end 45, a middle section 46, and a second end 47, wherein the first end 45 is proximal to the electric motor 60 and the second end 47 is proximal to the unsprung element 16. As shown and in one embodiment, the stator magnet assembly 44 substantially completely extends axially along the stator frame 42 from the first end 45 to the second end 47.

The rotor screw 50 includes a rotor magnet assembly 54 fabricated on an outer surface of a cylindrically-shaped frame 52 that couples to a rotatable shaft 58 coupled to a rotor 66 of the electric motor 60. The rotor magnet assembly 54 includes a plurality of permanent magnet elements each having north polarity portion 55 and south polarity portion 57 arranged to form a continuous helical magnetic thread having the same pitch as the helical magnetic thread of the stator magnet assembly 44. The rotor magnet assembly 54 is arranged as a plurality of interleaved permanent magnet sections forming a spirally-wound thread formed from radially polarized magnets of opposite polarity. The rotor frame 52 is preferably fabricated from iron or other ferromagnetic material in this embodiment. The rotor magnet assembly 54 is characterized by a rotor magnet axial length 58 and the stator magnet assembly 44 is characterized by stator magnet axial length 48. In one embodiment and as shown, the stator magnet axial length 48 is substantially equal to the length of the stator frame 42 and the rotor magnet axial length 58 is determined based upon a desired magnetic force coupling, which is determined in conjunction with diameters of the rotor screw 50 and the stator nut 40. Magnetic force coupling as defined and used herein refers to a magnitude of magnetic force exerted between two adjacent elements, e.g., the rotor 50 and the stator nut 40 of the MLS 30, and can be measured and indicated by a magnitude of linear force or rotational torque that is required to move one of the elements relative to the other element.

The outer diameter of the rotor screw 50 is sized to fit concentrically one within the inner diameter of the stator nut 40 without physical contact. The magnet fluxes of the elements align themselves to a null force position when no external forces are applied. Parameters that affect design of the magnetic force coupling include the diameters of the rotor screw 50 and the stator nut 40, thread pitch and clearance between the facing surfaces of the rotor magnet assembly 54 and the stator magnet assembly 44. Diameters are selected based upon a trade-off between surface area, affecting the magnetic force coupling between the magnets, and physical size affecting packaging and cost. Thread pitch is selected based upon trade-offs between activation torque for the electric motor 60, and a desired rotational speed and corresponding response time as indicated by a time-rate change in length of the MLS 30 caused by rotation of the rotor screw 50 relative to the stator nut 40. The clearance between the facing surfaces of the rotor magnet assembly 54 and the stator magnet assembly 44 is selected based upon a trade-off between mechanical design considerations such as manufacturing and assembly tolerances and a desired magnetic force coupling. A magnetic lead screw has no mechanical contacts associated with vertical force transfer and hence has low friction and wear. Low friction forces facilitate improvement in suspension performance while low wear increases reliability and reduces maintenance.

The electric motor 60 includes a motor rotor 66 arranged within a concentric motor stator 64 that is mounted in a frame 62 that couples to the sprung member 10. The motor rotor 66 rotatably couples to the MLS rotor screw 50 via shaft 58. Other motor elements such as bearings and retainers are included as necessary for operation, but are not shown herein. The electric motor 60 may be any suitable electric motor configuration capable of controlled rotation in both clockwise and counter-clockwise directions. Suitable electric motor configurations include a synchronous motor, an induction motor, or a permanent magnet DC motor. In one embodiment, the electric motor 60 is configured as a motor/generator. A motor controller 70 electrically couples to the electric motor 60 via electrical cables. The motor controller 70 includes, e.g., power switches to transform electric power transferred between an electric power storage device (e.g. battery) 90 and the electric motor 60 in response to control commands originating from a controller 80. The electric motor 60 is configured to exert sufficient torque to overcome rotational inertia including the magnetic force coupling between the rotor magnet assembly 54 and the stator magnet assembly 44 to spin the rotor 50 at a rate that causes a change in length of the MLS 30 at a preferred rate, e.g., as measured in mm/msec.

Movement of the sprung element 10 relative to the unsprung element 16 exerts either compressive or tensile force on the MLS damper 25. In either case, such compressive or tensile force causes rotation of the rotor screw 50 relative to the stator nut 40, and rotation of the rotor screw 50 occurs in concert with rotation of the rotor 66 of the electric motor 60. The electric motor 60 can operate as a motor to rotate in either the clockwise direction or the counterclockwise direction to rotate the rotor screw 50 and thus extend the length of the MLS damper 25 or shorten the length of the MLS damper 25. In addition, presence of compressive or tensile force on the MLS damper 25 can cause rotation of the rotor screw 50 relative to the stator nut 40, which occurs in concert with rotation of the rotor 66 of the electric motor 60. The electric motor 60 can operate as a generator in either the clockwise direction or the counterclockwise direction to rotate with the rotor screw 50 when the length of the MLS damper 25 is either extended or shortened in response to the tensile or compressive force.

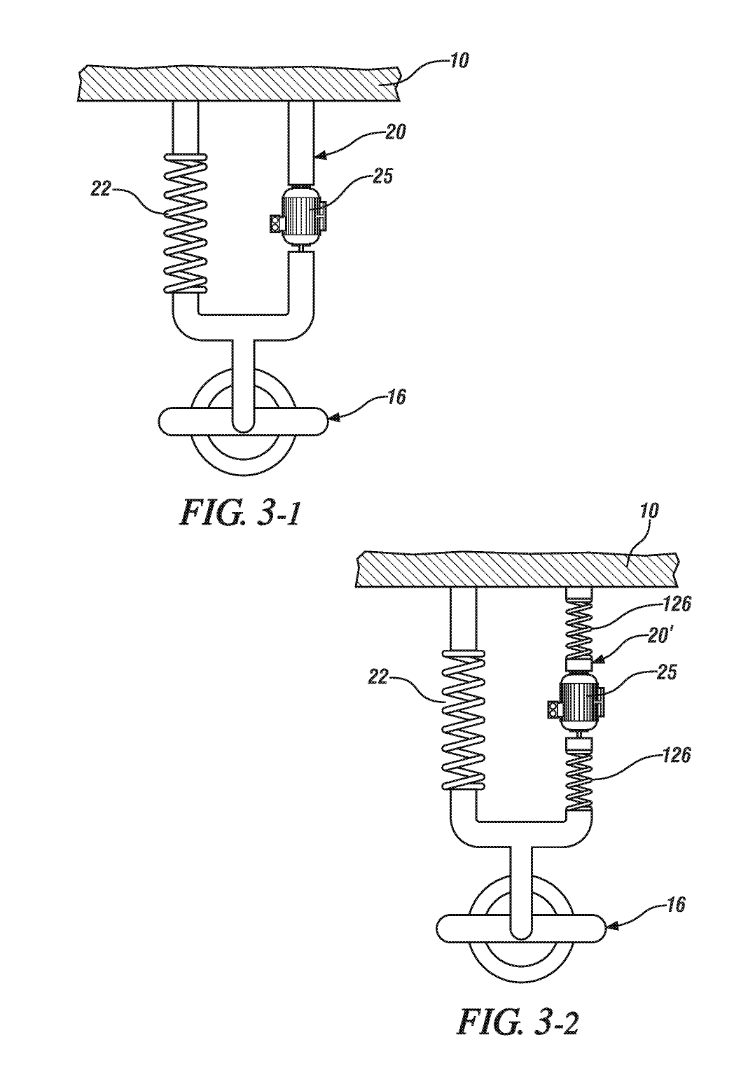

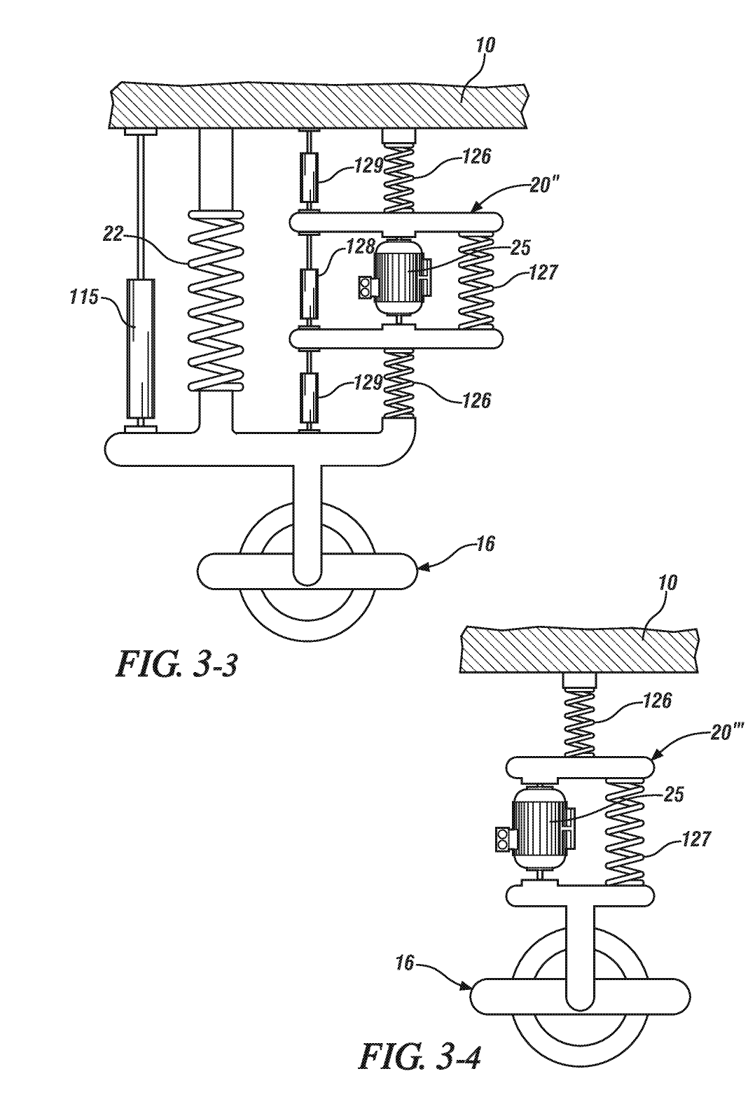

FIG. 3-1 schematically shows a first embodiment of a suspension assembly 20 coupled between sprung element 10, e.g., a vehicle chassis, and unsprung element 16, e.g., a vehicle wheel. Load-carrying spring 22 is coupled between sprung element 10 and unsprung element 16. MLS damper 25 is coupled between sprung element 10 and unsprung element 16. This embodiment of the suspension assembly 20 includes the load-carrying spring 22 arranged in parallel with MLS damper 25 with the parallel arrangement coupled between the sprung element 10 and the unsprung element 16. No other suspension elements are included. Movement of the sprung element 10 relative to the unsprung element 16 exerts either compressive or tensile force on the MLS damper 25 that transforms into rotation of the rotor screw relative to the stator nut to extend or shorten the length of the MLS damper 25 at a rate that effects damping of the spring 22 in response to an external force acting on the chassis or the wheel, such as a bump or a curve in the road. When the external force exceeds a magnetic force coupling in the MLS damper 25, the MLS damper 25 may skip a thread, but the effect of skipping a thread fails to cause mechanical damage to the MLS damper 25.

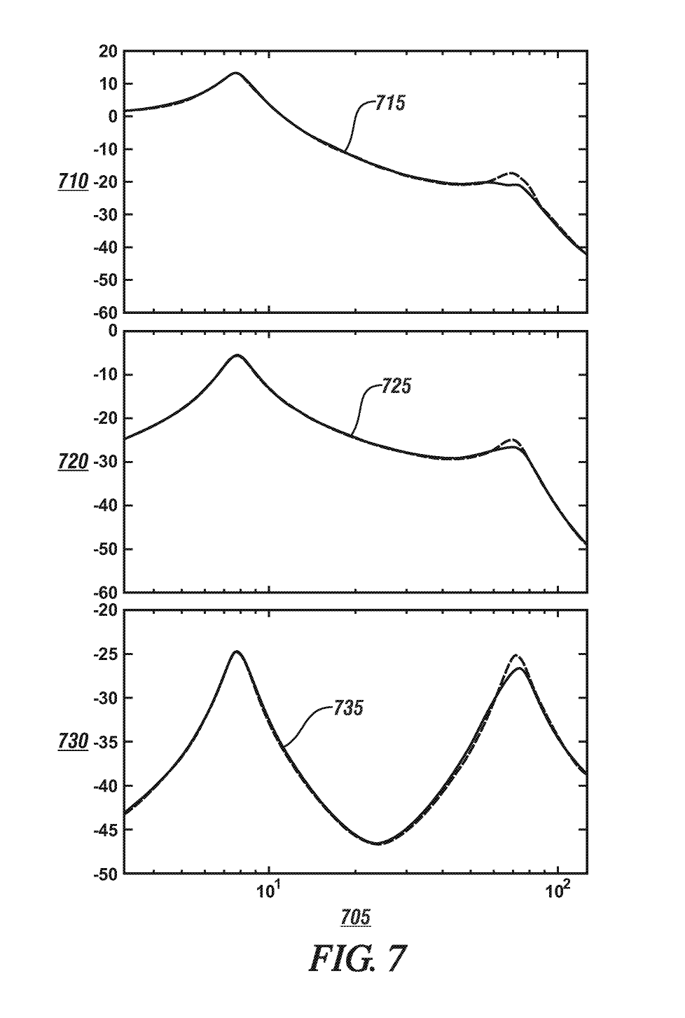

FIG. 3-2 schematically shows a second embodiment of a suspension assembly 20′ coupled between sprung element 10, e.g., a vehicle chassis, and unsprung element 16, e.g., a vehicle wheel. As in FIG. 3-1, load-carrying spring 22 is coupled between sprung element 10 and unsprung element 16, and MLS damper 25 is coupled between sprung element 10 and unsprung element 16. This embodiment of the suspension assembly 20′ includes the load-carrying spring 22 arranged in parallel with a series arrangement of the MLS damper 25 and at least one spring 126. However, the MLS damper 25 is shown arranged between a pair of springs 126 in series arrangement in FIG. 3-2 for illustration and is not limiting. The MLS damper 25 has a spring action that can be stiff, and thus may be more harsh than desired in some applications. The in-series springs 126 soften the harshness effect of the rotational inertia and reduce likelihood of thread skipping in the MLS damper 25. The additional mass from the motor and MLS of the MLS damper 25 in combination with appropriately tuned spring rates for the springs 126 can advantageously provide a tuned mass damper that dampens vibration inputs occurring at a specific frequency, e.g., 8 to 10 Hz, to reduce wheel hop, thus improving ride and tire grip. FIG. 7 graphically shows frequency response data associated with design of one embodiment of a tuned mass damper.

FIG. 3-3 schematically shows a third embodiment of a suspension assembly 20″ coupled between sprung element 10, e.g., a vehicle chassis, and unsprung element 16, e.g., a vehicle wheel. As in FIGS. 3-1 and 3-2, load-carrying spring 22 is coupled between sprung element 10 and unsprung element 16, and MLS damper 25 is coupled between sprung element 10 and unsprung element 16. Additionally, various dampers 115, 128 and 129 are shown coupled between sprung element 10 and unsprung element 16, and various additional springs 127 and 129 are shown coupled between sprung element 10 and unsprung element 16. This embodiment of the suspension assembly 20″ includes the load-carrying spring 22 arranged in parallel with damper 115 and in parallel with a spring/damper assembly that includes MLS damper 25. The spring/damper assembly includes a first subassembly that includes the MLS damper 25 arranged in parallel with spring 127. Damper 128 is also illustrated in parallel with MLS damper 25 and spring 127. The first subassembly is arranged in series with at least one spring 126 arranged in parallel with a corresponding damper 129. However, a pair of such parallel arrangements of spring 126 and damper 129 is shown in FIG. 3-3 for illustration and is not limiting. Various other combinations among springs 126, 127 and dampers 128, 129 that make up the spring/damper assembly, including combinations wherein one or more of the springs 126, 127 and dampers 128, 129 may be excluded, are envisioned. Therefore, the inclusive illustration of FIG. 3-3 is understood not to exclude such combinations of less than all springs 126, 127 and dampers 128,129 as such various combinations are within the skill of one having ordinary skill in the art in light of this disclosure. The addition of dampers 115, 128 and 129 and springs 126 and 127, in various combinations and with appropriately tuned spring rates, can advantageously provide a mass damper that is tuned to dampen at several frequencies of interest as understood by one having ordinary skill in the art.

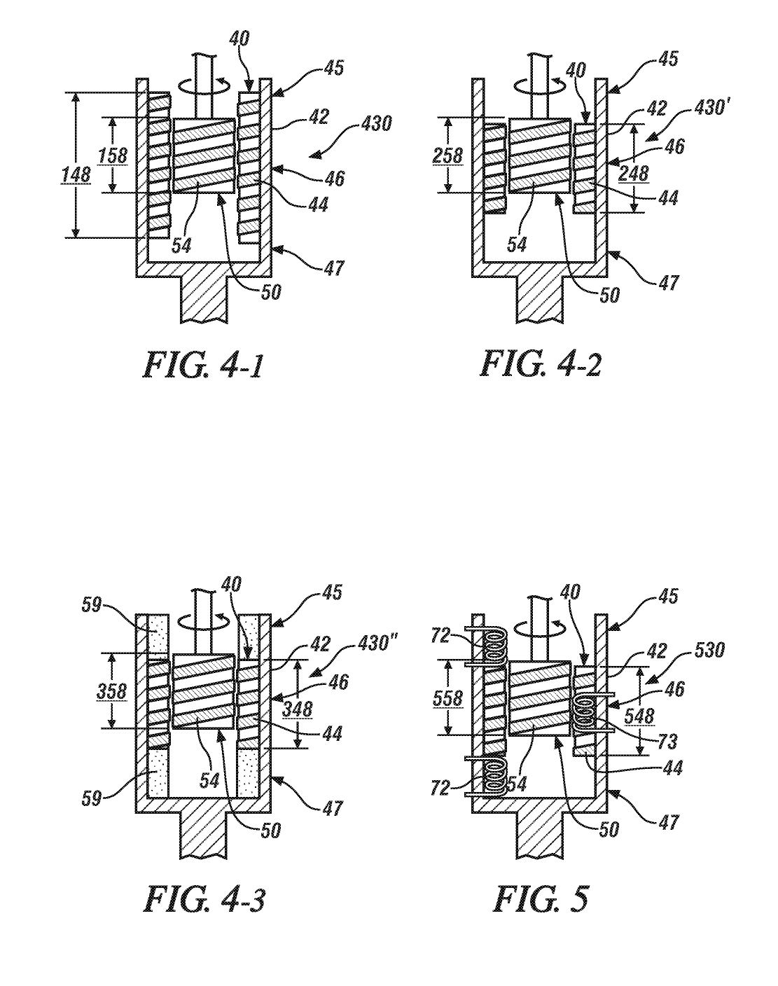

FIG. 3-4 schematically shows another embodiment of a suspension assembly 20′″ coupled between sprung element 10, e.g., a vehicle chassis, and unsprung element 16, e.g., a vehicle wheel. This embodiment of the suspension assembly 20′″ includes spring 126 arranged in series with a parallel arrangement of spring 127 and MLS damper 25.

FIG. 4-1 schematically shows portions of an embodiment of the MLS 430 including stator nut 40 having frame 42 and stator magnet assembly 44 and rotor 50 including rotor magnet assembly 54. The rotor magnet assembly 54 is configured with a rotor magnet axial length 158 and the stator magnet assembly 44 is configured with stator magnet axial length 148. In this embodiment, the stator magnet assembly 44 extends axially along the stator frame 42 from the first end 45 to the second end 47 and the stator magnet axial length 148 is substantially equal to a length of the stator frame 42. The rotor magnet axial length 158 is determined based upon a desired magnetic force coupling, which is determined in conjunction with diameters of the rotor screw 50 and the stator nut 40. The rotor magnet axial length 158 is less than the stator magnet axial length 148. In this configuration, the rotor magnet assembly 54 is completely contained within the stator magnet assembly 44 along its length from a fully extended state of the MLS 430 to a fully retracted state of the MLS 430. Thus, the magnetic force coupling exerted between the stator magnet assembly 44 and the rotor magnet assembly 54 is constant from the fully extended state to the fully retracted state of the MLS 430.

FIG. 4-2 schematically shows portions of another embodiment of the MLS 430′ including stator nut 40 having frame 42 and stator magnet assembly 44 and rotor 50 including rotor magnet assembly 54. In this embodiment, the stator magnet assembly 44 extends axially along the stator frame 42 only in the middle section 46, and not to the first end 45 or the second end 47. In this embodiment, stator magnet axial length 248 corresponds in length to rotor magnet axial length 258. The rotor magnet axial length 258 is determined to achieve a desired magnetic force when the system on which the MLS 430′ is applied is static and under static loading conditions with the spring supporting all of the load input from the chassis and the MLS damper at nominal displacement. In this configuration, the rotor magnet assembly 54 completely conforms to the stator magnet assembly 44 along its length only when the applied system is static at nominal displacement. Rotation of the rotor 50 in the stator nut 40 linearly translates the rotor 50 relative to the stator nut 40, thus displacing the rotor magnet assembly 54 relative to the stator magnet assembly 44 and either extending or retracting the MLS 430′. This results in a portion of the rotor magnet assembly 54 moving beyond the stator magnet assembly 44 with a corresponding reduction in the magnetic force coupling between the stator magnet assembly 44 and the rotor magnet assembly 54. Thus, the magnetic force coupling exerted between the stator magnet assembly 44 and the rotor magnet assembly 54 is maximized when the applied system is at static loading conditions with the spring 22 supporting all of the load input from the chassis and the MLS damper at nominal displacement, and decreases as the MLS 430′ extends or retracts. Modifying the stator magnet axial length 248 and the rotor magnet axial length 258 to adjust the overlap length, e.g., as shown, permits modification of behavior of the MLS 430′, including such operations as non-magnetic damping.

FIG. 4-3 schematically shows portions of another embodiment of an MLS 430″ including stator nut 40 having frame 42, stator magnet assembly 44 and one or more conductive inserts 59, and rotor 50 including rotor magnet assembly 54. In this embodiment, the stator magnet assembly 44 extends axially along the stator frame 42 only in the middle section 46, and not to the first end 45 or the second end 47, and stator magnet axial length 348 corresponds in length to the rotor magnet axial length 358. The rotor magnet axial length 358 is selected to achieve a desired magnetic force coupling when the system on which the MLS 430″ is applied is static and under static loading conditions with the spring supporting all of the load input from the chassis and the MLS damper at a nominal displacement. The conductive inserts 59 are annular devices fabricated from non-ferromagnetic conductive materials such as copper, aluminum, or another suitable material that induces eddy currents in the presence of a permanent magnet or an electromagnet. The conductive inserts 59 are located in the stator nut 40, preferably at the first end 45 and at the second end 47. Alternatively, a conductive insert can be located exclusively at the first end or exclusively at the second end. When the stator magnet axial length 348 corresponds in length to the rotor magnet axial length 358, the rotor magnet assembly 54 completely conforms to the stator magnet assembly 44 along its length only when the MLS 430″ is at nominal displacement. Movement of the rotor 50 toward either the extended state or the retracted state results in a portion of the rotor magnet assembly 54 moving beyond the stator magnet assembly 44 and moving proximal to the conductive inserts 59. The interaction of the rotor magnet assembly 54 with the conductive inserts 59 causes eddy currents that generate a magnetic force that acts to arrest movement of the rotor magnet assembly 54. Thus, damping is effected by generating eddy currents between the rotor magnet assembly 54 in close contact with the conductive inserts 59. The magnetic force coupling between the stator magnet assembly 44 and the rotor magnet assembly 54 is maximized when the MLS 430″ is at nominal displacement, and decreases as the MLS 430″ extends or retracts. Modifying the stator magnet axial length 348 and the rotor magnet axial length 358 to adjust the overlap length, e.g., as illustrated, permits modification of behavior of the MLS 430″. Alternatively, the conductive inserts 59 are annular devices fabricated from ferromagnetic conductive materials such as iron, or another suitable material that induces magnetic hysteresis to effect damping by arresting movement of the rotor magnet assembly 54 in the presence of a permanent magnet or an electromagnet.

FIG. 5 schematically shows portions of another embodiment of an MLS 530 including stator nut 40 having frame 42, stator magnet assembly 44 and electric coil elements 72 and 73, and rotor 50 including rotor magnet assembly 54. In this embodiment, stator magnet axial length 548 is substantially equal to rotor magnet axial length 558. The rotor magnet axial length 558 is determined to achieve a desired magnetic force when the MLS 530 is static at a nominal displacement. The electric coil elements 72 can be located in the stator nut 40 at the first end 45 and at the second end 47 adjacent to the unsprung element. Electric coil elements 73 can also be collocated with the stator magnet assembly 44, converting the stator magnet assembly 44 to a controllable electromagnetic device. In this configuration, the stator magnet assembly 44 extends axially along the stator frame 42 only in the middle section 46, and not to the first end 45 or the second end 47, and stator magnet axial length 548 corresponds in length to the rotor magnet axial length 558. Movement of the rotor 50 toward either the extended state or the retracted state results in a portion of the rotor magnet assembly 54 moving beyond the stator magnet assembly 44 and moving proximal to the electric coil elements 72. The interaction of the rotor magnet assembly 54 with the electric coil elements 72 generates a magnetic force coupling that acts to arrest movement of the rotor magnet assembly 54. The magnetic force coupling between the stator magnet assembly 44 and the rotor magnet assembly 54 is maximized when the MLS 530 is static at a nominal displacement. Under dynamic operating conditions, electric power flow to the electric coil elements 73 collocated with the stator magnet assembly 44 can be controlled to increase or decrease the magnetic force coupling between the stator magnet assembly 44 and the rotor magnet assembly 54, thus adjusting the responsiveness of the MLS 530.

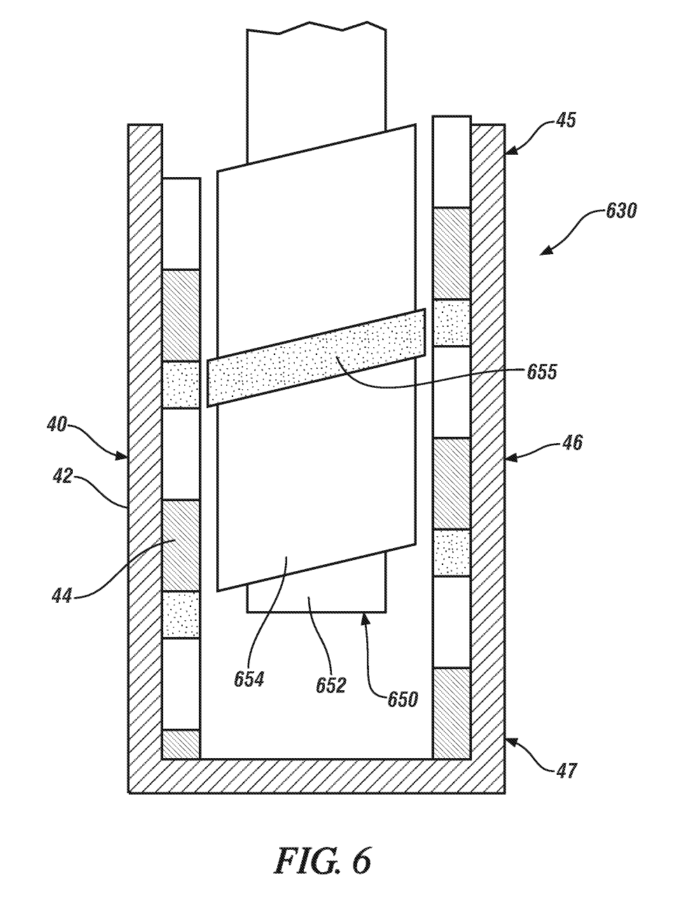

FIG. 6 schematically shows portions of an embodiment of an MLS 630 including stator nut 40 having frame 42 and stator magnet assembly 44 and rotor 650. The rotor 650 is configured with a core 652 for mounting a ferromagnetic threaded portion 654 that is separated by a non-ferromagnetic thread separator 655, both which are adjacent to the stator magnet assembly 44. The core 652 can be a ferrous element, or alternatively a non-ferrous element that couples to the shaft 58 of the motor rotor. The stator magnet assembly 44 extends axially along the stator frame 42 from the first end 45 to the second end 47 with a stator magnet axial length that is substantially equal to a length of the stator frame 42. Thus, the rotor 650 is completely contained within the stator magnet assembly 44 along its length from a fully extended state of the rotor 650 to a fully retracted state of the rotor 650 in the stator nut 40. Thus, the magnetic force coupling is constant from the fully extended state to the fully retracted state of MLS 630. In this embodiment, the rotation of the rotor 650 relative to the stator nut 40 can be resisted by employing reluctance torque generated between the rotor 650 and the stator magnet assembly 44. The stator magnet assembly 44 may include a controllable electromagnet in one embodiment, with corresponding capability to control the magnetic force coupling between the rotor 650 and the stator magnet assembly 44.

FIG. 7 graphically shows frequency response data in terms of body movement or ride (mm) 710, wheel vertical travel (mm) 720 and tire deflection or grip (mm) 730 in relation to frequency (Hz) 705 associated with an embodiment of the suspension assembly 20′ of FIG. 3-2 wherein the MLS damper is part of an embodiment of a tuned mass damper arranged between the vehicle chassis and the vehicle wheel of FIG. 3-2. The depicted data includes body movement or ride 715, wheel vertical travel 725 and tire deflection or grip 735 plotted in relation to frequency. The in-series springs 126 can be tuned to soften harshness in combination with additional weight from the MLS damper 25 to provide a tuned mass damper that dampens at a specific frequency, e.g., 8 Hz, to reduce wheel hop, thus improving ride and tire grip.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A suspension assembly between a sprung element and an unsprung element, comprising:
a load-carrying spring coupled between the sprung element and the unsprung element;
a magnetic lead screw damper coupled between the sprung element and the unsprung element;
the magnetic lead screw damper comprising a magnetic lead screw arranged in series with an electric motor;
the magnetic lead screw comprising a rotor screw and a stator nut;
said rotor screw comprising a rotor magnet assembly forming first helical magnetic threads, said rotor screw rotatably coupled to the electric motor;
said stator nut comprising a stator magnet assembly forming second helical magnetic threads, and a stator frame;
said stator magnet assembly comprising an axial length equal to an axial length of the rotor magnet assembly; and
wherein rotation of the rotor screw effects linear translation of the stator nut by interaction of the first and second helical magnetic threads.

2. The suspension assembly of claim 1, wherein the load-carrying spring and the magnetic lead screw damper are arranged in parallel.

3. The suspension assembly of claim 1, wherein a magnetic force coupling between the stator magnet assembly and the rotor magnet assembly is at a maximum state at a static loading condition with the load-carrying spring supporting the sprung element and the magnetic lead screw damper at a nominal displacement.

4. The suspension assembly of claim 1, wherein a magnetic force coupling between the stator magnet assembly and the rotor magnet assembly is at a maximum state at a static loading condition with the load-carrying spring supporting the sprung element and the magnetic lead screw damper at a nominal displacement for the sprung element and wherein the magnetic force coupling decreases with displacement of the magnetic lead screw that either extends or retracts the magnetic lead screw damper.

5. The suspension assembly of claim 1, wherein said stator magnet assembly is mounted on a middle portion of the stator frame and said stator nut further comprises a conductive insert adjacent to the stator magnet assembly at one end of the stator frame.

6. The suspension assembly of claim 5, wherein the conductive insert comprises an annular device fabricated from non-ferromagnetic conductive material.

7. The suspension assembly of claim 5, wherein the conductive insert comprises an annular device fabricated from ferromagnetic conductive material.

8. The suspension assembly of claim 1, further comprising a controllable electrical coil located on a first end and a second end of the stator magnet assembly

9. The suspension assembly of claim 1, wherein said stator magnet assembly is mounted on a middle portion of the stator frame and said stator nut further comprises a first conductive insert at a first end of the stator frame adjacent to the stator magnet assembly and a second conductive insert at a second end of the stator frame adjacent to the stator magnet assembly.

10. The suspension assembly of claim 1, wherein the stator magnet assembly further comprises a controllable electromagnetic magnet device including an electrical coil, said coil collocated with the stator magnet assembly and controllable to dynamically adjust the magnetic force coupling between the stator magnet assembly and the rotor magnet assembly.

11. The suspension assembly of claim 1, further comprising at least one spring arranged in series with the magnetic lead screw damper, wherein the load-carrying spring is arranged in parallel with the series arrangement of said at least one spring and the magnetic lead screw damper.

12. The suspension assembly of claim 11, further comprising at least one damper coupled between the sprung element and the unsprung element.

13. The suspension assembly of claim 12, wherein said at least one damper coupled between the sprung element and the unsprung element is arranged in parallel with the load-carrying spring.

14. The suspension assembly of claim 12, wherein said at least one damper coupled between the sprung element and the unsprung element is arranged in parallel with the magnetic lead screw damper.

15. The suspension assembly of claim 12, wherein said at least one damper coupled between the sprung element and the unsprung element is arranged in parallel with said at least one spring.

16. The suspension assembly of claim 11, wherein said at least one spring arranged in series with the magnetic lead screw damper comprises the magnetic lead screw damper arranged between a pair of springs.

17. The suspension assembly of claim 16, further comprising a spring arranged in parallel with the magnetic lead screw damper.

18. The suspension assembly of claim 17, further comprising a damper arranged in parallel with the magnetic lead screw damper.

19. The suspension assembly of claim 17, further comprising a damper arranged in parallel with one of said pair of springs.

20. The suspension assembly of claim 16, wherein each of said pair of springs comprises respective preferred spring constants and the magnetic lead screw damper comprises a preferred mass, the respective preferred spring constants and the preferred mass selected to effect damping at a selected frequency associated with an undesirable operating frequency between the sprung element and the unsprung element.

21. The suspension assembly of claim 1, wherein a magnetic force coupling between the stator magnet assembly and the rotor magnet assembly is at a constant state with displacement of the magnetic lead screw that either extends or retracts the magnetic lead screw damper.

22. A suspension assembly between a sprung element and an unsprung element, comprising:
a first spring arranged in parallel with a magnetic lead screw damper, said parallel arrangement of the first spring and magnetic lead screw damper arranged in series with a second spring;
the magnetic lead screw damper comprising a magnetic lead screw coupled in series with an electric motor;
the magnetic lead screw comprising a rotor screw and a stator nut;
said rotor screw comprising a rotor magnet assembly forming first helical magnetic threads, said rotor screw rotatably coupled to the electric motor;
said stator nut comprising a stator magnet assembly forming second helical magnetic threads, and a stator frame;
said stator magnet assembly comprising an axial length equal to an axial length of the stator frame; and
wherein rotation of the rotor screw effects linear translation of the stator nut by interaction of the first and second helical magnetic threads.

23. The suspension assembly of claim 22, wherein a magnetic force coupling between the stator magnet assembly and the rotor magnet assembly is at a constant state with displacement of the magnetic lead screw that either extends or retracts the magnetic lead screw damper.

24. A suspension assembly between a sprung element and an unsprung element, comprising:
a load-carrying spring arranged in parallel with a magnetic lead screw damper between the sprung element and the unsprung element, wherein the load-carrying spring supports the sprung element and the magnetic lead screw damper at a nominal displacement under a static loading condition;
the magnetic lead screw damper comprising a magnetic lead screw coupled in series with an electric motor, the magnetic lead screw comprising a rotor screw including a rotor assembly forming first helical threads fabricated from ferromagnetic material, said rotor screw rotatably coupled to the electric motor and a stator nut comprising a stator frame and stator magnet assembly forming second helical magnetic threads;
wherein rotation of the rotor screw effects linear translation of the stator nut by interaction of the first helical threads and the second helical magnetic threads.
